(19) United States
(12) Patent Application Publication
(10) Pub. No.: US 2003/0060218 A1
(43) Pub. Date: Mar. 27, 2003

(54) Automated tuning of wireless peripheral devices

(75) Inventors: Bryed Billerbeck, Mountain View, CA (US); Peter Thompson, Millbrae, CA (US); Thomas C. Lyon, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A.

(21) Appl. No.: 10/199,962

(22) Filed: Jul. 19, 2002

Related U.S. Application Data
(60) Provisional application No. 60/308,304, filed on Jul. 27, 2001.

(51) Int. Cl. H04B 7/00; H04Q 7/00

(52) U.S. Cl. 455/501; 455/500

(57) ABSTRACT

A system and a method for the automatic tuning of wireless peripheral devices, such as wireless keyboards, mice and digital cameras by providing a host transceiver in connection with a host via a bus, the host transceiver having a plurality of antennas configured to receive and send data between a host and a peripheral device, and a host-resident software program which causes the host to select the antenna having a higher signal quality as the most productive antenna to transfer data between the host and the peripheral device. All the complexity of the antenna selection operation is achieved by a host-resident software program, which periodically measures the signal quality of each antenna, compares the signal qualities and selects the higher signal quality antenna to transfer data between the host and the peripheral device. Signal quality is assessed based on the signal level, signal-to-noise ratio or other signal quality indicators for the signal provided by the antenna. The periodic measurements of signal quality, which are performed by the host-resident software program, are carried out in a manner to minimize any potential discontinuities in the reception of signals transferred between the host and the peripheral device.

### CROSS-REFERENCE TO RELATED APPLICATION

The present application claims priority to U.S. Provisional Patent Application No. 60/308,304, filed Jul. 27, 2001, the teachings of which are hereby incorporated by reference in their entirety for all purposes.

### BACKGROUND OF THE INVENTION

The present invention relates to wireless peripheral devices, and in particular to wireless peripheral devices in communication with a host. More specifically, the present invention relates to the automated tuning of wireless peripheral devices via a diversity antenna system.

Many peripheral device vendors have decided to cut the cord that connects the peripheral device with its host. For example, many vendors presently offer wireless peripheral devices such as wireless keyboards and computer input devices such as computer mice. Typically, in such systems, the tethered connection is replaced by a wireless device that transmits to a receiver/transmitter, where the receiver/transmitter is connected via a communication bus with a host such as a personal computer.

While a wireless connection provides many advantages over a tethered one, it does introduce certain unique problems. These unique problems include reception anomalies due to reception interference. These anomalies occur at each point in the receiving space where the first and a reflected transmission waves sum to zero or near zero at the receiver. The locations of these zeros will depend on the length of the two paths, which in turn depend on the location of the transmitter relative to the receiver, as well as the location of object in between. There may also be multiple secondary reflected waves that produce similar points of poor or zero recaption. Another challenge faced by peripheral device manufacturers is maintaining costs down, while providing high quality devices.

A solution to this reception problem involves a technique that is known in RF circles. This technique is commonly known as diversity reception or antenna diversity, and is used primarily in wireless telecommunication devices. Antenna diversity is used in antenna-based communications systems to reduce the effects of multi-path distortion fading. Antenna diversity may be obtained by providing a receiver with two or more antennas. The diversity reception system then chooses the signal provided by the most productive antenna for a given location of transmitter and receiver. Diversity reception techniques typically involve the incorporation of additional hardware and circuitry on the receiver and/or the transmitter end of the wireless system. This additional hardware and circuitry adds costs and complexities that may be absorbable for higher end telecommunications devices (e.g., cell phones), but would diminish or entirely remove the profitability from a low cost consumer wireless peripheral device. Furthermore, a hardware-based solution, once implemented becomes very expensive to enhance, while most, if not all, peripheral devices generally benefit from periodic updates.

Another solution to the reception problems in wireless systems involves the manual (frequency) tuning of the peripheral and or the receiver, to ensure a satisfactory reception. While this method may provide a solution, it will require access to the device by an operator to tune the device, which may not always be possible. Another shortcoming of the manual tuning approach is that it is a one-time or static tuning and thus may require subsequent manual tunings. Furthermore, while the manual approach may address the tuning needs where the system is limited to a pair of transmitter/receivers, the manual approach is not as effective for the tuning of a system that includes more than one transmitter sending their data to a common receiver, since the receiver can at best be tuned to only one of the transmitters.

There is therefore a need for a low cost system that can automatically address reception issues in wireless peripheral devices.

### BRIEF SUMMARY OF THE INVENTION

The present invention provides systems and methods for the automatic tuning of wireless peripheral devices, such as wireless keyboards, mice and electronic cameras by providing a host transceiver in connection with a host via a bus, the host transceiver having a plurality of antennas configured to receive and send data between a host and a peripheral device, and a host-resident software program which causes the host to select the antenna having a higher signal quality as the most productive antenna to transfer data between the host and the peripheral device. All the complexity of the antenna selection operation is achieved by a host-resident software program, which periodically measures the signal quality of each antenna, compares the signal qualities and selects the higher signal quality antenna to transfer data between the host and the peripheral device. Signal quality is assessed based on the signal level, signal- to-noise ratio or other signal quality indicators for the signal provided by the antenna. The periodic measurements of signal quality, which are performed by the host-resident software program, are carried out in a manner to minimize any potential discontinuities in the reception of signals transferred between the host and the peripheral device.

The implementation of a software-based scheme to select an antenna on a transceiver connected with a host, by the host computer, reduces hardware costs, and provides a system that can be easily upgraded. For a further understanding of the nature and advantages of the present invention, reference should be made to the following description in conjunction with the accompanying drawings.

### BRIEF DESCRIPTION OF THE DRAWINGS

FIG. 1 is a block diagram of the automated tuning system according to an embodiment of the present invention.

FIG. 2 is a flow chart of an embodiment of the automated tuning method of the present invention.

### DETAILED DESCRIPTION OF THE INVENTION

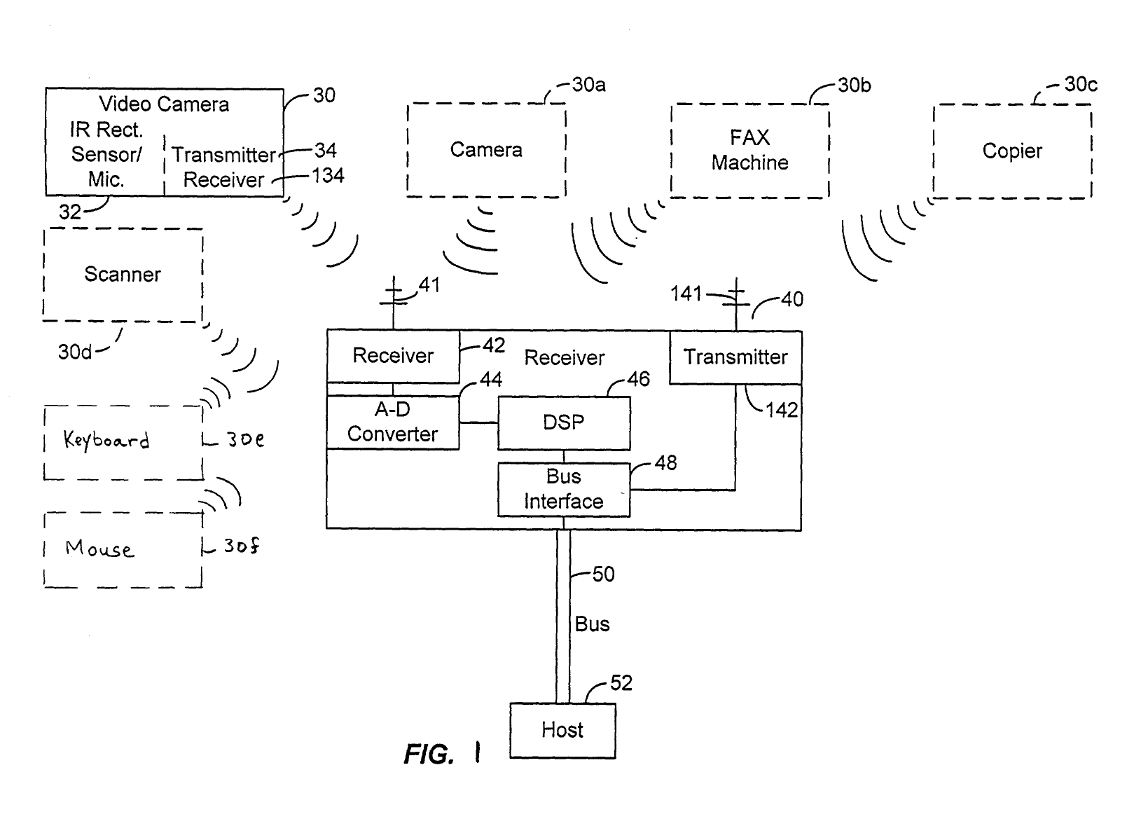

FIG. 1 is a diagram of a system for implementing the automatic tuning scheme according to embodiments of the present invention. This system is illustrative of a system that implements the automatic tuning scheme of the present invention and is not meant to be limiting of the scope of the embodiments of the present invention. Since the bi-directional nature of transmission and reception between a peripheral device and a host are intimately related, the detailed description provided below describes both the forward and the back channel operations. Forward channel operation refers to the transmission of image, sound and data (including control signals) from the peripheral device to the host, and back channel operation refers to the transmission of control signals from the host to the peripheral device.

FIG. 1 shows a wireless system for transmission and reception of images, sound and data from a video camera 30 to a receiver unit 40 which is tethered to a host 52 via a bus 50 according to one embodiment of the forward channel operations associated with the present invention. FIG. 1 also shows one embodiment of the back channel system which provides control signals from the host 52 via the bus 50 to a transmitter 142, in the same receiver unit 40, and via wireless transmission to the camera 30. This system includes a broadcast device or a camera unit 30 and a receiver unit 40. The camera unit 30 receives as input image, audio and data, converts their respective signals to an analog format (or leaves them in an analog format) and broadcasts them to the receiver unit. The receiver unit 40 receives the broadcast signals, converts them to digital format, and does the necessary processing to fit the bandwidth of the bus to which it is communicating. In addition to camera 30, the system may include a second camera 30a, and additional devices such as a FAX machine 30b, a copier 30c, a scanner 30d, a wireless keyboard 30e, a wireless computer mouse 30f or other network peripheral devices such as telephones, video phones, teleconference and video conference devices.

As can be seen in FIG. 1, one embodiment of the camera unit is comprised of three sub units. The first sub unit performs the function of sensing the video image, the second sub unit performs the transmission function, and the third sub unit is the receiver. The first sub unit may also include a microphone and an IR receiver, and a control circuit which generates control data for transmission. The control circuit also processes command signals for execution. The three sub units can be integrated at the sub assembly level in multiple chips or at the integrated circuit level in one chip, which can be an application specific integrated circuit (ASIC).

FIG. 1 illustrates the main sub units of one embodiment of the receiver unit 40. These are an antenna array 41, a receiver 42, an analog to digital converter (ADC) 44, a processor (e.g. digital signal processor “DSP”) 46, and a bus interface unit 48. Antenna array 41 includes a plurality of antennas, which are spatially separated from one another, and from which the host will select the most productive one as a source of received data, as is described below. Antenna array 41 receives the broadcast signal from the camera unit 30. The broadcast signal is passed to the receiver 42 to down convert it to an intermediate frequency and demodulate the signal back to its separate image, audio and data base band signal portions. The base band analog signals are converted to digital format signals by the ADC 44, which passes the digital format signals to a DSP 46 which performs one or more of the compression, cropping, scaling, color processing and other functions on the data, as well as digital filtering. Once processed, the digital signal is provided to a bus interface 48. The bus interface 48 receives the digital signal from the DSP 46 and processes it to fit the bandwidth of the bus 50 to which it is communicating. Bus 50 transmits the signals processed by the DSP 46 to a host processor 52 which will respond to the transmitted data signal, and/or display the video signal and/or playback the transmitted audio signal.

In one example, a broadcast frequency of 65.5 MHz (Channel 3) is used for the video camera 30, with other frequencies (Channels 1, 2 and 4) being used for the other broadcast devices. In an embodiment, the transmitter 34 includes a mixer, which varies its center frequency between 907 MHz and 925 MHz. The receiver 42 down converts to an intermediate frequency of 45 MHz. In addition to the frequency ranges set forth above, the embodiments of the present invention equally encompass transmission of data including image data over other frequency ranges including, for example, the 27 MHz, 900 MHz, 2.4 GHz, 5 GHz as well as other as are known to those of skill in the art.

In one embodiment, referred to as an external receiver embodiment, the bus 50 is a universal serial bus (USB), or an IEEE 1394 bus (such as Apple's trademarked FireWire® bus) or a parallel port. Alternately, in an imbedded receiver embodiment, the bus is an inter integrated circuit (IIC) bus. In addition to the communication interface protocols set forth above, other protocols including serial communication as well as other as are know to those of skill in the art are within the scope of the present invention. These communications protocols are not meant to limit the scope of the embodiments of the present invention.

The various embodiments of the host 52 include typical processors such as: a personal computer (PC), a television set top box (STB), a network computer, a workstation, a server, a router, a switch, a hub, a bridge, a printer, a copier, a scanner, a fax machine, a modem, a network appliance, a game station, a cellular phone, or any device where images, audio and data are displayed, further processed, viewed, hard copied or distributed over a network. Instead of a camera, the invention could receive broadcast signals from an electronic pen, a scanner, copier, FAX machine, photographic processor or any other device, which receives, processes, or simply retransmits data including image data.

The receiver unit 40 of FIG. 1 is a receiver for image, sound and data from the peripheral devices 30, 30a-f, and it also is a transmitter of control signals from a host 52 via a bus 50 to the peripheral devices 30, 30a-f. As can be seen from FIG. 1, the receiver unit 40 includes a transmitter 142 and an antenna array 141 to transmit control signals to the peripheral devices 30, 30a-f. Antenna array 141 includes a plurality of antennas, from which the host will select the most productive one to transmit data to the peripheral device, as is described below. In one embodiment of the command channel, a control signal is provided by the host 52 and is transmitted to the external receiver unit 40 via the bus 50. The control signal is passed to the transmitter 142 where it is converted to a broadcastable format signal, which is radiated out by the transmitting antenna array 141. Specific control signal examples include: power on/off, display format settings, location signals, channel select, volume up/down, mode, pan, tilt, zoom, dial, call, answer, display, audio on/off, data on/off, subtitle on/off, connect, and disconnect. Specific examples of display format signals include full, picture in picture (PIP), common intermediate format (CIF), quarter CIF (QCIF), source input format (SIF), quarter SIF (QSIF), VGA, PAL and NTSC. The broadcast control signals are then received by the receiver on the peripheral device such as receiver 134 on the video camera unit 30.

In one embodiment, the camera and the receiver module can be of a form described in a copending U.S. patent application Ser. No. 09/440,827, entitled “Wireless Intelligent Host Imaging, Audio and Data Receiver,” assigned to the assignee herein, the entire disclosure of which is hereby incorporated herein by reference.

Furthermore, as described above, the transmit/receive system described above, also includes command channel or back channel operations configured to send data from the host back to the peripheral device. The back channel operations can be of a form described in a copending U.S. patent application Ser. No. 09/439,736, entitled “Wireless Network Device Command Channel,” assigned to assignee herein, the entire disclosure of which is hereby incorporated herein by reference.

A computer program (not shown) is loaded and executed on the host 52 to measure the signal quality of the received signal on the receiving antenna array 41, and to select the most productive antenna as the source of received signals. Likewise, the same computer program is used to select the most productive antenna from the antenna array 141 to transmit data to the peripheral device.

In general terms, embodiments of the present invention utilize diversity reception, which is a technique known in the RF arena. Diversity reception systems typically involve the spacing of multiple antennas some fraction of a wavelength apart and then choosing the most productive antenna for any given combination of transmitter and receiver. In embodiments of the present invention, the multiple antennas are used on the host receiver, and the host, which is connected with the host receiver, through the operation of a host-side software program automatically selects the most productive antenna based on a desired signal characteristics measured from each of the several antennas. The measurement of the signals and switching between antennas usually occurs during blanking or other non-data-transmit intervals, but is not limited to these intervals, to minimize any potential discontinuity in reception. The measurement of signals and switching between antenna are made periodically so that even if the peripheral device (e.g., camera, mouse, keyboard, pen, scanner, printer and so on) or objects in the field are in motion, reception anomalies are continuously minimized, thus allowing for an improved reception.

It is known that in a diversity reception scheme, an increase in the number of antennas, results in a proportional improvement in the overall reception. For example, a two-antenna system will correct at least 80% of anomalies, and a three-antenna system will correct up to 95% of anomalies. Antenna as used herein includes any body connected with the host receiver that is capable of receiving (or transmitting) RF signals and hence may include the cable connecting the host receiver with the host.

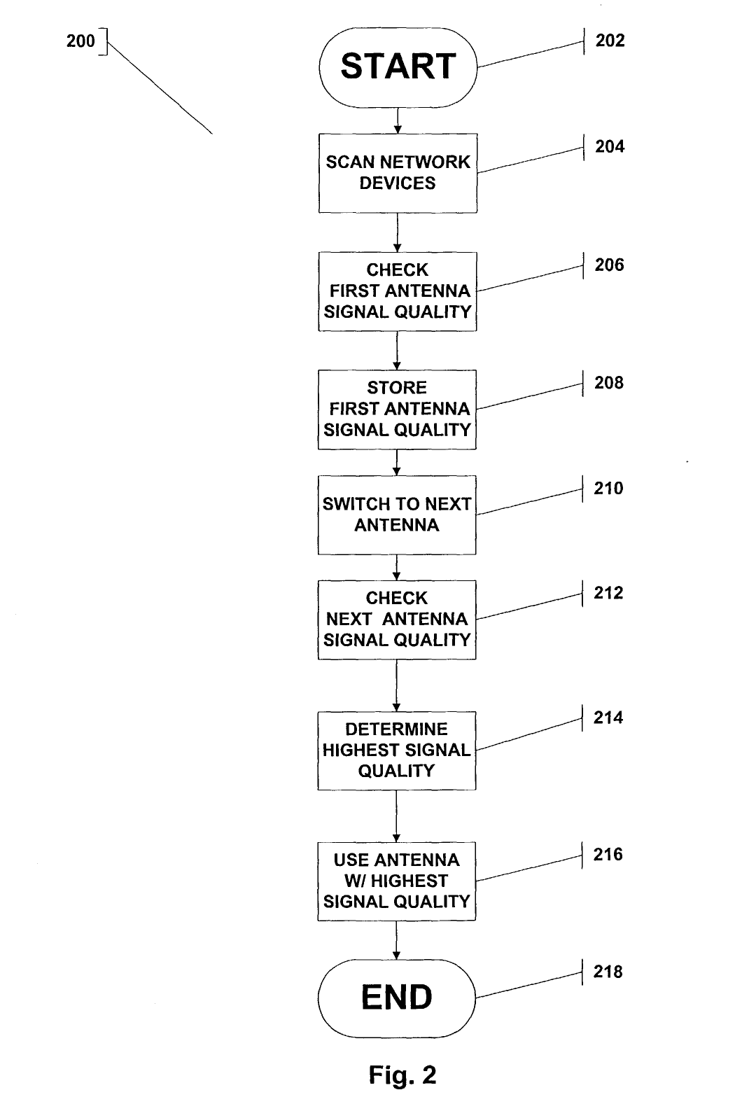

FIG. 2 is flow chart 200 of an embodiment of the method of the present invention, which is used to select the most productive antenna on the host receiver for receiving data from or transmitting data to the peripheral device. Once the software has been loaded and initialized (step 202), which in one embodiment occurs as a part of the host's normal startup, the software causes the host to scan for network transmitters (step 204). Network transmitters are, for example, any of devices 30 a-f. This step (step 204) occurs in response to the host receiver 40 beginning to receive transmission signals from various remote devices 30a-f. Next, the software program determines a measure of the received signal's quality as received by the first antenna (step 206). In one embodiment, the signal quality indicator is the absolute value of the signal's level. In an alternate embodiment, the signal quality indicator is the signal-to-noise ratio of the received signal. Other signal quality measures as are known in the art may also be used to assess the quality of the signal. The measured signal quality indicator from the first antenna is then stored (step 208). Next, the software causes the system (i.e., host and host receiver) to switch to the next receiving antenna (step 210), and a measure of the signal quality is obtained for the next antenna (step 212). This process (steps 210-212) is repeated for all the antennas in the system. A comparison is made next (step 214) and the antenna providing the highest signal quality is selected (step 216). The selected antenna is used to receive data from transmitting devices until it is time to compare antennas again, at which time step 204 -216 are repeated again.

Another aspect of the present invention is directed to the back channel or command channel operations of the host receiver. The software-diversity scheme according to embodiments of the present invention also enables significant improvements to the functionality of the back channel operations. In a back channel, or command channel mode, where the host receiver is transmitting and the wireless device is receiving, data is sent from the host to the wireless device (e.g., camera, mouse, keyboard, pen, scanner, printer and so on). Just as in the “forward” transmission mode, where reception problems could arise in sending data to the host, in the “backward” transmission mode, reception problems could arise in sending data from the host. To address the back channel reception issues, the host is used to control the choice of the antenna on the receiver, which is used for the transmission of data to the wireless peripheral (e.g., camera, mouse, keyboard, pen, scanner, printer and so on ). In one embodiment, to determine which transmitting antenna is the most productive one, a “token” is transmitted by each of the receiver's antennas to the peripheral device. The peripheral device then sends back the tokens; the host compares the returned token to the transmitted one, and depending on how the tokens came back, the host selects the antenna which resulted in the better returned token as the most productive one for the transmission of commands from the host to the peripheral device.

One advantage of the automatic tuning system of the present invention is its ease of use. The host-based application program measures antenna performance and selects the most productive antenna based on the quality of the signal. As described above, most wireless systems typically require that the peripheral device or the receiver be adjusted manually for an optimum reception. If subsequently the camera or the receiver is moved, the other may need to be adjusted accordingly for an optimum reception. The automated tuning approach according to embodiments of the present invention alleviates the need for manual adjustments.

Another advantage of the embodiments of the present invention is better expressed in the case of multiple peripheral devices (e.g., cameras, mice, keyboards, pens, scanners, printers and so on). An example of such a multiple peripheral system is the case of multiple cameras transmitting image data to the same host, via one host receiver, as in a home security system, where one camera may be configured to “look” at the front door of a house and another may be configured to look at the swimming pool and another camera may be “looking” at a sleeping child. In such an arrangement, it will be difficult, if not nearly impossible to optimize the reception quality of all cameras transmitting to a single stationary receiver. For example, without the methods and systems of the present invention, every time a different camera is selected, the operator will need to adjust the receiver or the receiver's antenna to achieve an optimum reception. The methods and systems of the present invention will cause the host computer, via the execution of the host-resident software, to automatically select the best antenna depending on each transmitting device. Therefore, using the methods and systems of the present invention, the host computer will automatically select the best receiver antenna for any camera view selected without the need to move the receiver or the receiver antenna.

Another advantage of the embodiments of the present invention is that it allows for the minimization of the costs of the transmitter for the peripheral device (e.g., a camera). A camera can have a very simple low power fixed position omni-directional antenna, hence avoiding antennas that are adjustable relative to the camera, and which are more costly. Without the automatic tuning functionality provided by the host-resident software, a wireless camera would need either an adjustable antenna, which add additional costs to the cost of the camera, or the camera's position would have to adjusted for an optimum reception at the host. However, in a monitoring application, the camera needs to be positioned for its desired view, and not the direction of its antenna for a best transmission. Therefore, by having the antenna array of the diversity reception arrangement on the intelligent host receiver and the measurement and selection algorithms performed by the host-resident software, camera costs can be minimized.

The migration of the complexity and intelligence from the transmitting device to the host-resident software program is even more advantageous when multiple camera views are simultaneously being displayed on one host, via a host receiver. In such a scenario, multiple economies will be realized by having multiple low-cost cameras transmitting to a single host receiver, thus allowing an overall low cost system.

Yet another advantage of the method and system of the present invention is that the signal measurement, and antenna selection is carried out by a host-resident software program. Using software instead of hardware allows for a very efficient and low cost method of updating the measurement and selection algorithms. As more efficient or improved algorithms are developed, the system's software is easily upgraded without requiring the more expensive hardware retrofits.

In an alternate embodiment of the present invention, the diversity reception method is implemented as firmware in an operating-system-based host on a general purpose or application specific chip coupled with the host. Yet alternately, the diversity method is implemented as firmware on a non-operating-system-based integrated circuit.

Furthermore, as set forth above, the diversity reception methodology in accordance with embodiments of the present invention utilizes a plurality (at least two) of antennas for the reception and/or transmission of data. The plurality (at least two) of antennas may be on the transmitting or receiving device, or alternately the diversity scheme may use antennas that are shared or able to be shared in a device resident network as in a wireless network, such as, for example, a Bluetooth-based network. An example of such a network is a Bluetooth-enabled network where many devices are communicating with one another in a given area in a networked manner. In such an environment, a transmitting or receiving device may use an antenna of another device as an alternate (i.e. diversity) antenna to avoid a null in order to receive or send a signal having a higher signal quality. In this manner, the diversity reception approach in accordance with embodiments of the present invention will use the most productive antenna for receiving or sending data, and the most productive antenna can either be an alternate antenna on the receiving or sending device or alternately an antenna on another device within the network.

As will be understood by those skilled in the art, the present invention may be embodied in other specific forms without departing from the essential characteristics thereof. For example, the antenna selection algorithm may be based on signal quality indicators other than signal-to-noise or signal level, such as the signal's history or variance. These other embodiments are intended to be included within the scope of the present invention, which is set forth in the following claims.

What is claimed is:

1. A system for wireless transfer of data between a peripheral device and a host, said system comprising:
a peripheral device configured to wirelessly transfer data;
at least two receiving antennas configured to receive said data from said peripheral device to produce at least two received signals, where each of said received signals has a corresponding signal quality;
a receiver connected with said at least two antennas, said receiver configured to process said received signals;
a bus coupled with said receiver;
a host connected with said receiver via said bus, said host configured to process said received signals; and
a computer useable medium having computer readable code embodied therein for causing said host to select one of said at least two antennas, said computer readable code further comprising:
(i) a signal quality measuring code portion configured to cause said host to measure said signal quality of said received signals;
(ii) a signal quality comparing code portion configured to cause said host to compare said signal quality of said received signals; and
(iii) an antenna selecting code portion configured to cause said host to select one of said antennas, depending on said signal quality, wherein said selected antenna is used to send data to be processed by said receiver for transfer with said host.

2. The system of claim 1 wherein said receiver further comprises at least two transmitting antennas for the transmission of data from said host to said peripheral device, where each of said transmitting antennas provides a transmitted signal having a corresponding signal quality, and where said peripheral device is configured to wirelessly receive data.

3. The system of claim 2 wherein said computer useable medium further includes a computer readable code embodied therein for causing said host to select one of said at least two transmitting antennas, said computer readable code further comprising:
(i) a transmitting signal quality measuring code portion configured to cause said host to measure a transmitting signal quality for each of said transmitting antennas;
(ii) a signal quality comparing code portion configured to cause said host to compare said transmitting signal quality for each of said transmitting antennas; and
(iii) a transmitting antenna selecting code portion configured to cause said host to select one of said transmitting antennas, depending on said transmitting signal quality, wherein said selected transmitting antenna is used to transfer data with said peripheral device.

4. The system as in any one of claims 1-3, where said signal quality is selected from the group consisting of a signal-to-noise ratio, signal level and combinations thereof.

5. The system of claim 1 wherein said peripheral device is selected from the group consisting of a digital camera, a computer keyboard, a computer mouse and combinations thereof.

6. The system of claim 1 wherein said bus is selected from the group consisting of a universal serial bus, an inter integrated circuit bus, an IEEE 1394 bus, a serial port, a parallel port, an enhanced parallel port and an extended capabilities port.

7. The system of claim 1 wherein said host is selected from the group consisting of a personal computer, a handheld computer, an interactive set-top box, an interactive game console, a thin client computing device, a cellular telephone, an internet appliance, an electronic image display, a TV, a projector, a media burner, a media player, a printer, a photo finishing kiosk and combinations thereof.

8. A wireless transceiver system configured to transfer data between a peripheral device and a host, said system comprising:
at least two antennas configured to transfer data between said peripheral device and said host;
a transceiver connected with said at least two antennas, said transceiver configured to process said data;
a host configured to be connected with said transceiver via a bus, said host configured to process said data; and
a computer useable medium having computer readable code embodied therein for causing said host to select one of said at least two antennas, said computer readable code further comprising:
(i) a signal quality measuring code portion configured to cause said host to measure a signal quality of a signal for each of said antennas;
(ii) a signal quality comparing code portion configured to cause said host to compare said signal quality for each of said antennas; and
(iii) an antenna selecting code portion configured to cause said host to select one of said antennas, depending on said signal quality, wherein said selected antenna is used to transfer data between said host and said peripheral device.

9. The system of claim 8 wherein said signal quality is selected from the group consisting of a signal-to-noise ratio, signal level and combinations thereof.

10. The system of claim 8 wherein said peripheral device is selected from the group consisting of an electronic camera, a computer keyboard, a computer mouse and combinations thereof.

11. The system of claim 8 wherein said host is selected from the group consisting of a personal computer, a handheld computer, an interactive set-top box, an interactive game console, a thin client computing device, a cellular telephone, an internet appliance, a digital picture frame and combinations thereof.

12. A method of selecting an antenna from at least two antennas which are configured to transfer data between a peripheral device and a host, said method comprising:
continuously measuring a first signal quality from a first antenna;
continuously measuring a second signal quality from a second antenna;
comparing said first signal quality with said second signal quality; and
selecting one of said at least two antennas having a higher signal quality to transfer data between said peripheral device and said host, where said measuring and said comparing is performed by said host.

13. The method of claim 12 wherein said signal quality is selected from the group consisting of a signal-to-noise ratio, signal level and combinations thereof.

14. The method of claim 12 wherein said peripheral device is selected from the group consisting of a digital camera, a computer keyboard, a computer mouse and combinations thereof.

15. The method of claim 12 wherein said host is selected from the group consisting of a personal computer, a handheld computer, an interactive set-top box, an interactive game console, a thin client computing device, a cellular telephone, an internet appliance, an electronic image display, a TV, a projector, a media burner, a media player, a printer, a photo finishing kiosk and combinations thereof.
